(19) United States
(12) Patent Application Publication
(10) Pub. No.: US 2014/0272769 A1
(43) Pub. Date: Sep. 18, 2014

(54) FLUID ACTIVATED SWITCH FOR ORAL IRRIGATOR

(71) Applicant: Water Pik, Inc., Fort Collins, CO (US)

(72) Inventors: Harold A. Luettgen, Windsor, CO (US); Theodore De Leo, Fort Collins, CO (US); Oscar Senff, Broomfield, CO (US)

(73) Assignee: Water Pik, Inc., Fort Collins, CO (US)

(21) Appl. No.: 14/216,792

(22) Filed: Mar. 17, 2014

Related U.S. Application Data
(60) Provisional application No. 61/800,246, filed on Mar. 15, 2013.

(51) Int. Cl. A61C 17/028; A61C 17/16; A61C 1/00

(52) U.S. Cl. CPC A61C 17/028; A61C 1/0015; A61C 17/16
USPC 433/27; 433/215

(57) ABSTRACT

An oral irrigator including a reservoir, a handle, and a tip connected to the handle and in fluid communication with the reservoir. The oral irrigator also includes a base unit including an operating assembly configured to selectively provide a first fluid from the reservoir to the tip. The operating may include, an some examples, a motor and a pump. The oral irrigator further includes a fluid pressure trigger connected to the handle and including a second fluid. Based on a pressure of the second fluid, the fluid pressure trigger closes an electrical contact to the operating assembly causing the operating assembly to selectively vary at least one characteristic of the first fluid flow from the reservoir to the tip.

### TECHNICAL FIELD

The technology disclosed herein relates to health and personal hygiene equipment and methods of controlling such equipment. More particularly, the disclosure herein relates to switches utilized in oral irrigators.

### BACKGROUND

Conventional oral irrigators (water flossers) typically include a pump power on/off-switch on the irrigator base. Using a pump power on/off-switch on the irrigator base typically requires use of a second hand—the first hand holds the irrigator handle and second hand operates the pump power on/off-switch located on the base. Additionally, oral irrigators are typically used with the operator bent over a bathroom sink, allowing the water that is used during oral irrigation to spill into the sink and not onto the countertop. In this bent-over position, it is cumbersome for the operator to find the pump power on/off-switch on the irrigator base.

To alleviate some of these issues some conventional countertop oral irrigators include a pause button on the irrigator handle. This pause button merely blocks the flow of water inside the handle, leaving the electric water pump active. As a result, the water pressure inside the oral irrigator rises dramatically. Even if the oral irrigator includes pressure relief valves, these high water pressures may be capable of damaging the components within the oral irrigator pump.

The information included in this Background section of the specification, including any references cited herein and any description or discussion thereof, is included for technical reference purposes only and is not to be regarded subject matter by which the scope of invention is to be bound.

### SUMMARY

An oral irrigator includes a handle that controls a countertop base unit. The handle can selectively control the delivery of fluid to the oral irrigator handle. The handle includes a fluid pressure actuator located within the handle. The fluid pressure actuator may be triggered by pressing a button on the fluid pressure actuator. The base unit includes a fluid pressure switch and a pump driven by a motor. A first fluid conduit and a second fluid conduit may connect the oral irrigator base unit and the oral irrigator handle. The fluid pressure switch may be in fluid communication with the fluid pressure actuator through the second fluid conduit. The fluid pressure switch may be in electrical communication with a controller within the oral irrigator base unit.

Other embodiments may include a method for activating and deactivating an oral hygiene pump by changing the activation state of a motor utilizing a button on an oral irrigator handle. Depressing the button may increase a fluid pressure in a conduit within the oral irrigator handle. This fluid pressure may be communicated to a switch in the base unit. A signal (e.g., a start/stop signal) may be transmitted from a processor on a circuit board to a switch through a first terminal. The fluid pressure may close a contact in the switch. The closed contact may connect the first terminal with a second terminal. Closing the contact in the switch may communicate the signal (e.g., the start/stop signal) through the second terminal back to the processor and circuit board (i.e., the controller). Receiving the signal may cause the processor and circuit board to start or stop the motor. Stopping the motor may stop the pump causing the handle to stop receiving water. Starting the motor may start the pump causing the handle to receive water.

Yet other embodiments include an oral irrigator including a reservoir, a handle, a tip connected to the handle and in fluid communication with the reservoir. The oral irrigator also includes a base unit including an operating assembly configured to selectively provide a first fluid from the reservoir to the tip. The operating may include, an some examples, a motor and a pump. The oral irrigator further includes a fluid pressure trigger connected to the handle and including a second fluid. Based on a pressure of the second fluid, the fluid pressure trigger closes an electrical contact to the operating assembly causing the operating assembly to selectively vary at least one characteristic of the first fluid flow from the reservoir to the tip.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is an isometric view of an exemplary embodiment of a countertop oral irrigator system.

FIG. 2 is a side elevation view in cross section taken along line A-A shown in FIG. 1 of the countertop oral irrigator system of FIG. 1.

FIG. 3 is a front isometric view of an oral irrigator handle and switch assembly of the oral irrigator system of FIG. 1.

FIG. 4 is a left side elevation view in cross-section of a portion of the oral irrigator handle including the fluid pressure actuator assembly taken along line B-B shown in FIG. 3.

FIG. 5 is an exploded isometric view of a pressure actuated switch and fluid pressure actuator assembly.

FIG. 6A is a front right isometric view of an actuator back plate of the fluid pressure actuator assembly.

FIG. 6B is a front isometric view of the actuator back plate.

FIG. 6C is a side elevation view in cross section of the actuator back plate taken along line F-F shown in FIG. 6B.

FIG. 7 is a right side elevation view in cross section of an actuator diaphragm taken along line C-C shown in FIG. 5.

FIG. 8 is a right side elevation view in cross section of an actuator collar taken along line E-E shown in FIG. 5.

FIG. 9 is a right side elevation view in cross section of an actuator button taken along line D-D shown in FIG. 5.

FIG. 10 is an enlarged view of a portion of FIG. 4.

FIG. 11A is an isometric view of a pressure actuated switch top plate of a switch connected with the fluid pressure actuator assembly.

FIG. 11B is a bottom plan view the pressure actuated switch top plate of FIG. 11 A.

FIG. 11C is a side elevation view in cross section of the pressure actuated switch top plate of FIG. 11A taken along line G-G of FIG. 11 B.

FIG. 12A is an isometric view of a pressure actuated switch bottom plate of the fluid pressure actuator assembly.

FIG. 12B is a side elevation view in cross section of the pressure actuated switch bottom plate of FIG. 12A taken along line H-H shown in FIG. 12A.

FIG. 13A is a top isometric view of a pressure actuated switch membrane of the switch connected with the fluid pressure actuator assembly.

FIG. 13B is a top plan view of the pressure actuated switch membrane of FIG. 13A.

FIG. 13C is a side elevation view in cross section of a pressure actuated switch membrane taken along line I-I shown in FIG. 13B.

FIG. 14A is a top isometric view of a pressure actuated switch contact plate of an exemplary embodiment of a conduit.

FIG. 14B is a side elevation view in cross-section along line J-J shown in FIG. 14A of a pressure actuated switch contact plate.

FIG. 15 is an enlarged view of a portion of FIG. 4.

FIG. 16A is an isometric view of an exemplary embodiment of a conduit.

FIG. 16B is an end view of the conduit of FIG. 16A.

FIG. 17A is an isometric view of an exemplary embodiment of a conduit.

FIG. 17B is an end view of a conduit of FIG. 17A.

FIG. 18A is an isometric view of an exemplary embodiment of a conduit.

FIG. 18B is an end view of the conduit of FIG. 18A.

FIG. 19A is an isometric view of an exemplary embodiment of a conduit.

FIG. 19B is an end view of the conduit of FIG. 19A.

FIG. 20A is an isometric view of an exemplary embodiment of a conduit.

FIG. 20B is an end view of the conduit of FIG. 20A.

FIG. 21 is a flow diagram of a method for operating an oral irrigator with a fluid pressure switch In exemplary embodiments.

### DETAILED DESCRIPTION

A system for providing control of a fluid delivered from a fluid source unit to a handheld dispenser, e.g., an oral irrigator, a pressure washer, water fountain, or other similar systems is disclosed herein. The fluid delivery is controlled by communicating a fluid (either compressible on non-compressible) between the handheld dispenser and the fluid source. For example, a fluid pressure trigger in a hand-held dispenser may control a switch in the fluid source. The actuator or fluid may be a pneumatic actuator that is actuated by air or another gas, or may be a hydraulic actuator actuated by a fluid such as water, oil, or the like. In short, the fluid actuated trigger may be actuated by a change in pressure by substantially any type of fluid and/or gas.

In some embodiments, the hand-held dispenser may be an oral irrigator including a fluid pressure trigger or switch. The trigger includes a user actuatable button connected to a bellows or diaphragm. As the user actuates the switch, the bellows compresses and air or another fluid may be forced through various fluid passageways to reach a diaphragm connected to one or more electrical contacts. The pressure exerted by the air expands or lifts the diaphragm, forcing the electrical contacts positioned on the diaphragm to contact an electrical switch, which may activate, deactivate, or change a state of a motor, pump, or other component of the oral irrigator. Various aspects of this technology are described below with reference to the accompanying figures.

With reference to FIG. 1, an oral irrigator may include a handle 130, a base 140, a reservoir 150, and a power supply 160. The handle 130 may include a tip 134, a body 132 and an actuator 240. The actuator 240 may be suitably located on the body 132 to allow a user to easily contact the actuator with at least one of an operator's fingers, e.g., the thumb. The handle 130 may be in communication with the base 140 through a fluid conduit 120. In various embodiments, the handle 130 may be in communication with the base 140 through additional fluid conduits such as a fluid conduit 110. As discussed in more detail below, the fluid conduit 120 and the fluid conduit 110 may be separate tubes connecting the handle 130 and the base 140, or the fluid conduit 120 and the fluid conduit 110 may be structurally integrated with one another.

With reference to FIG. 2, the base 140 may contain one or more of an electromagnetic actuator 210, a pump 220, a circuit board 250 with a microprocessor 260, and a switch 230. The reservoir 150 may be in fluid communication with the pump 220 through a fluid conduit 152. The fluid conduit 152 fluidly connects with the pump 220 at a pump inlet 222. The pump 220 may be connected to or integral with the electromagnetic actuator 210. The electromagnetic actuator 210 may be an electric motor. The electromagnetic actuator 210 may be in electrical communication with the circuit board 250. For example, the electrical communication may be through one or more signal supply wires 280. The controller may include the circuit board 250, a microprocessor 260, and the power supply 160. In various embodiments, the circuit board 250 may be in electrical communication with the switch 230. For example, the electrical communication may be through one or more signal supply wires 270.

As discussed above, the handle 130 may include the tip 134 and the body 132. In exemplary embodiments, the handle 130 may additionally include the actuator 240. The handle 130 may be in fluid communication with the base 140. For example, one or more conduits may connect the base 140 with the handle 130. A first fluid conduit 120 connects to the pump 220 at a pump outlet 224 on a first end of the fluid conduit 120. The fluid conduit 120 may connect to the handle 130 on a second end. The fluid conduit 120 may connect with the tip 134 internally to the handle 130 on the second end of the fluid conduit 120. In various examples, a second actuator fluid conduit 110 may connect to the switch 230 at a first end of the actuator fluid conduit 110. The actuator fluid conduit 110 may connect to the handle 130 at a second end of the actuator fluid conduit 110. In various examples, the second end of the actuator fluid conduit 110 may connect with the actuator 240. As illustrated in FIGS. 3 and 4, the handle 130 may be in communication with the switch 230 via the fluid conduit 110.

In exemplary embodiments, as illustrated in FIG. 5, the actuator 240 may include an end cap 550, a bellows 560, a collar 580, a button 570, and a biasing member 590. With reference to FIGS. 6A-6C, the end cap 550 includes a conduit portion 631 and a cap or back plate portion 633. The back plate portion 633 extends from the conduit portion 631 and is fluidly connected therewith. The conduit portion 631 includes a neck 640 defining a flow pathway 669 therethrough. The flow pathway 669 has an inlet 664 and an outlet 662. The neck 640 extends downwards from a back end 635 of the plate portion 633. The neck 640 may include a bend 637 or inflection point such that a bottom end 639 of the neck 640 is angled relative to a top end 641.

A flange 650 extends downwards and outwards from the bottom end 639 of the neck 640. The flange 650 has a larger diameter than the neck 640 and is configured to receive a portion of the fluid conduit 110. For example, the flange 650 defines a conduit cavity 660. The conduit cavity 660 is fluidly connected to the pathway 669 by the neck outlet 662. An inner surface 643 of a top edge of the flange 650 may be beveled defining an angled surface. In angled inner surface 643 forms an opening 668 in the end cap 550, where the opening 668 may have a larger diameter than the diameter of the conduit cavity 660.

With continued reference to FIGS. 6A-6C, the plate portion 633 or manifold may be generally hollow cylindrical member with a closed back end 635 and an open front end 645. The back end 635 extends from the neck 640 and includes a raised portion 647 that forms an extra thickness of material at the connection location to the neck 640. The plate portion 633 includes a first annular wall 610 and a second annular wall 620 defining an annular channel 622 around an outer perimeter of the plate portion 633. The second annular wall 620 may have a lower height than the first annular wall 610 and an end face 624 may be beveled away from the channel 622. The channel 622 is therefore defined on a first side by the ridge formed by the first annular wall 610 and on the second side by second annular wall 620.

From the second annular wall 620, the plate portion 633 extends inwards defining a tapered wall 632. In this manner, the second annular wall 620 may extend circumferentially between the tapered wall 632 and the first annular wall 610. The tapered wall 632 extends outwards from the second annular wall 620 and is angled inwards towards a center of the plate portion 633. The tapered wall 632 includes a relatively flat top surface 630, the top surface 630 defining the opening to a cavity 651.

The main cavity 651 may vary in diameter from the top surface 630 towards a back wall 600. For example, a shelf 653 may extend inwards from an inner surface of plate portion 633 defining a spring receiving cavity 602. The spring receiving cavity 602 has a smaller diameter than the main cavity 651. A back wall 600 forms a back surface of the spring cavity 602 and the main cavity 651. The inlet 664 to the neck 640 is formed through the back wall 600, fluidly connecting the cavities 602, 651 to the pathway 669 in the neck 640. In some embodiments, the back wall 600 may be substantially coplanar with a front side of the first annular wall 610.

With reference to FIGS. 5 and 7, the bellows 560 may include a first end 710 and a second end 720. The first end 710 may be an annular flat surface. The first end 710 may be configured to contact and mate with the end cap 550. The second end 720 may be a flat circular surface. In some embodiments, the second end 720 may be sufficiently impermeable so as to limit and/or prevent air and/or fluids from passing through the surface. The second end 720 and the first end 710 may be connected by one or more walls forming a contiguous outer wall 740.

Similar to the second end 720, the contiguous outer wall 740 may be sufficiently impermeable so as to limit and/or prevent air from passing through the wall. The second end 720 includes an inner surface 722 forming a front wall of a bellows chamber 700. The outer wall 740 may have a corresponding inner surface such as inner wall 730. The plane formed by the first end 710, the inner wall 730, and the inner surface 722 may form the bellows chamber 700.

In exemplary embodiments, the outer wall 740 and the inner wall 730 may have a stepped profile including a first annular surface 742 and a second annular surface 750. For example, the sidewall 740 may be formed of a series stacked cylinders 741, 743, 745 having varying diameters. The stacked cylinders 741, 743, 745 may decrease in diameter from the first end 710 towards the second end 720 of the bellows 560. The first cylinder 741 may have the largest diameter, the second cylinder 743 extends from the first cylinder 741 and has the second largest diameter, and the third cylinder 745 extends from the second cylinder 743 and has the smallest diameter congruent with the second end 720.

The bellows 560 may include a tapered inner wall 712 proximal to the first end 710. In one example, the inner wall 712 may be at 45 degree angle from the plane formed by the top surface of the first end 710. In one example, the inner wall 712 may be at 37 degree angle from the plane formed by the first surface 710. An annular ridge 711 may extend radially outward from the first end 710.

With reference to FIGS. 5 and 8, the collar 580 may be understood as a cup=shaped body 802 defining a cavity 800. The body 802 may be annular and bound on a first end by a rim 810 and on a second end by an inwardly extending annual flange 870 that defines an opening 873. The body 802, a plane defined by the rim 810 and a plane defined by the second surface 842 may define the cavity 800. The collar 580 may have a larger opening 871 on the first end than the opening 873 on the second end 873. The size of the opening may be defined by the width 840 of the flange 870.

The interior of the wall 802 may include a recessed channel 860 defined a first channel side wall 820 and a second channel side wall 830. The channel 860 may be proximal to the rim 810 of the collar 580. The collar 580 may include an angled surface 850 on an interior edge of the rim 810. In one example, the angled surface 850 may be at a 45 degree angle from the plane formed by the first surface 810. In one example, the angled surface 850 may be at a 37 degree angle from the plane formed by the first surface 810.

With reference to FIGS. 5 and 9, the button 570 may include a body 930, a contact surface 940, and an engagement surface 910. The body 930 extends between the contact surface 940 and the engagement surface 910. The body 930 may be cylindrically shaped and may include one or more inside diameters. For example, a first inner wall 960 may define a first inner button diameter. A second inner wall 950 may define a second inner button diameter. The first inner wall 960 and the second inner wall 950 may be connected by step 970, between the first inner wall 960 and the second inner wall 950. In various examples, the first inner wall 960 may be larger in diameter than that second inner wall 950. The first inner wall 960 may be proximal to the engagement surface 910. The second inner wall 950 may be proximal to the contact surface 940. An interior volume 900 may be defined within the body 930 by a plane through the engagement surface 910 and an inner surface 942 of the contact surface 940. In some embodiments, the interior volume 900 may generally correspond to the outer perimeter of the second and third cylinders 743, 745 of the bellows 560. An annular protrusion 920 may extend outwardly from the wall 930 close to the rim 810.

In exemplary embodiments, the bellows 560 and the collar 580 may be separate components as illustrated in FIGS. 1-10. However, it may also be understood that the bellows 560 and the collar 580 may be a singular component having one or more of the features discussed herein for the bellows 560 and/or the collar 580.

In exemplary embodiments, as illustrated in FIG. 10 (with additional references to FIGS. 5-9), the actuator 240 may include one or more of the back plate 550, the spring 590, the bellows 560, the button 570, and the collar 580. One or more of the spring 590, the bellows 560, and the button 570 may be captured between the end cap 550 and the collar 580. The spring 590 is received into the spring receiving cavity 602 and a first end of the spring 590 seats on the back wall 600 of the end cap 550. The bellows 560 is received over the spring 590 and second end of the spring 590 seats against the inner surface 722 of the bellows 560.

The tapered surface 712 of the bellows 560 engages the tapered wall 632 of the end cap 550. The tapered surface 712 of the bellows 560 and the tapered wall 632 of the end cap 550 may correspond to one another such that the contact between the tapered surface 712 and the tapered wall 632 may be substantially air tight.

The bellows 560 is received into the interior volume 900 of the button 570. For example, the bellows 560 may be received such that the outer wall 740 may be adjacent to the first inner wall 960. The engagement surface 910 may be adjacent to the first annular surface 742. The inner surface 742 of the second wall 720 may be adjacent to the inner surface 942 of the button 570. The second annular surface 750 may be adjacent to the surface 970. The bellows 560 may be received into the button 570 such that in response to a force placed on the button 570, the button 570 may contact the bellows 560 at one or more of the second surface 720, the second annular surface 750, or the first annular surface 742.

The collar 580 connects the actuator assembly together. The collar 580 may retain the button 570 enclosed the bellows 560 and the spring 590 against the back plate 550. For example, the inner surface 840 may contact the annular protrusion 920 and the first channel surface 820 may contact a surface 624. To assemble the collar 580 and the back plate 550 in in this way, the angled surface 850 may slide over the second annular wall 620. The angled surface 850 may snap over the ridge formed by the surface 624 and the second annular wall 620. The collar 580 may be securely fastened to the end cap 550 by the engagement of the rim 820 on the collar 580 within the channel 622 in the back plate 550. The rim 810 is thus returned between the first annular wall 610 and the second annular wall 620. Additionally, the second annual wall 620 on the end cap 550 and the annular ridge 711 on the bellows 560 may be captured within the channel 860 in the collar 580.

One or more seals 542 may be received in the conduit cavity 660. The actuator fluid conduit 110 may be received in the conduit cavity 660. The actuator fluid conduit 110 and the conduit 669 may form a substantially continuous channel.

With reference to FIG. 5, the switch 230 may include one or more of a top plate 510, a switch plate 540, a contact 520, a diaphragm 530, the one or more of terminals 515, one or more fasteners 512, and one or more seals 542. The actuator fluid conduit 110 connects the actuator 240 to the switch 230. In various embodiments, the actuator 240 and the switch 230 may be in fluid communication with one another by a fluid contained within the actuator fluid conduit 110.

In exemplary embodiments, as illustrated in FIGS. 11A, 11B, and 11C, the top plate 510 may include a body 1100. The body 1100 may include one or more tabs 1105 that extend radially outward from a circumferential edge of the disk form of the body 1100. In the embodiment shown, three tabs 1105 are positioned equidistant apart about the perimeter. The tabs 1105 have though holes 1120 extending therethrough. The body 1110 may have a bottom surface 1101 configured to mate with a surface of another component. An interior volume 1142 may be defined by a plane passing through the bottom mating surface 1140 and an interior surface of the body 1100. The body 1100 may also have one or more terminal standoffs 1102 that extend upwardly. The terminal standoffs 1102 may be cylindrical protrusions extending out of the body 1100. The terminal standoffs 1102 may include through holes 1160 extending through the terminal standoffs 1102 and the body 1100. The body 1100 may have an annular lower wall 1150 which may extend downwardly. The lower wall 1150 may include a bottom mating surface 1140. The body 1100 may have an annular inner wall 1144 which may extend downwardly. In various embodiments, the lower wall 1150 may extend farther from the body 1100 than the inner wall 1144. However, it may be noted that in various embodiments, the inner wall 1144 may extend the same or farther from the body 1100 than the lower wall 1150. The body 1100 may include through holes 1106.

In exemplary embodiments, as illustrated in FIGS. 12A and 12B, the switch plate 540 may define an upper volume 1240 and a lower volume 1230. The upper volume 1240 may be defined by an upper wall 1210 (e.g., an annular wall), the plane of a top surface 1200 of the upper wall 1210, and an inner surface 1202. The lower volume 1230 may be defined by a lower wall 1220 (e.g., an annular wall), the plane of an annular bottom surface 1222 of the lower wall 1220, and an inner surface 1224. The lower volume 1230 may have an opening defined by the area inside of the annular bottom surface 1222. The opening may have a chamfer 1270 configured to aid in receiving assembled parts into lower volume 1230. The switch plate 540 may include a through hole 1260 extending between the upper volume 1240 and the lower volume 1230. One or more supports 1216 (e.g., protrusions or pads) may extend from the inner surface 1202. The switch plate 540 may include one or more support tabs 1205 (corresponding to the tabs 1105 on the top plate 510). For example, the one or more support tabs 1205 may extend from the upper wall 1210. The one or more support tabs 1205 may each have a though hole 1207. The switch plate 540 may include one or more mounting tabs 1272. For example, the one or more mounting tabs 1272 may extend from the upper wall 1210. The one or more mounting tabs 1272 may have a though hole 1274. The one or more mounting tabs may be configured to mount the switch 230 inside of the base 140.

In exemplary embodiments, as illustrated in FIGS. 13A, 13B, and 13C, the diaphragm 530 may be a circular flexible membrane with an outer flange ring 1300. In the embodiment shown, the diaphragm 530 may be circular with a though hole 1332 coaxial with the circular structure of the diaphragm 530. The though hole 1332 may include a standoff 1330 extending upwardly from a top surface 1340. The diaphragm 530 may include one or more support protrusions or bosses 1320 extending upwardly from the top surface 1340. The diaphragm 530 may include a diaphragm wall 1310. The diaphragm wall 1310 may be defined by an inner wall 1346 extending upwardly from the top surface 1340 and an outer wall 1344 extending upwardly from an outer flange 1300. The inner wall 1346 and the outer wall 1344 may intersect. The inner wall 1346 and the outer wall 1344 together may form an annular crease 1348 in the diaphragm 530. The annular crease 1348 may add to the flexibility of the diaphragm 530, specifically allowing deflection of the diaphragm 530 in response to receiving a force contacting a lower surface 1342 of a base 1352 of the inner wall 1346 and causing the inner wall 1346 to flex upward. The diaphragm 530 may define an inner volume 1360 by the top surface 1340, the inner wall 1346, and a plane defined by the top of the annular crease 1348 in the diaphragm wall 1310. The outer flange 1300 may include an exterior surface 1302 and a bottom surface 1350.

The contact 520 may be a conductive material or may be a non-conductive material laced with conductive particles. In some embodiments, the contact 520 and the diaphragm 530 may be a single component. For example, the contact 520 may be made from a conductive material and diaphragm 530 may have a conductive contact coating forming the contact 520. In other embodiments, the contact 520 may be adhered or otherwise connected to the diaphragm. The contact 520 may be positioned proximal to one or more of terminals 515 and be configured to flex sufficiently far to contact the conductive contact coating (and/or conductive material) against one or more of terminals 515. In such an embodiment, the single component may have one or more of the features of the contact 520 and the diaphragm 530.

In exemplary embodiments, as illustrated in FIGS. 14A and 14B, the contact 520 may include an upper engagement surface 1400 and a lower engagement surface 1460. In exemplary embodiments, the upper engagement surface 1400 and the lower engagement surface 1460 may be separated by cylindrical exterior wall 1430. The upper engagement surface 1400 may be an annular flange extending outwardly from the exterior wall 1430 with an exterior surface 1450 and a bottom surface 1470. The contact 520 may include an upper interior volume 1480 defined by a plane thorough the upper engagement surface 1400, a lower surface 1410, and the exterior wall 1430. A protrusion 1420 may extend from the lower surface 1410. In various embodiments, the protrusion 1420 may be centered within the lower surface 1410. The protrusion 1420 may define interior volume 1426 on the bottom side of the contact 520. For example, the lower interior volume may be defined by the plane of the lower engagement surface 1460, a lower interior wall 1424 and the surface 1422.

In exemplary embodiments, as illustrated in FIG. 15, the switch 230 may include one or more of the top plate 510, the switch plate 540, the contact 520, the diaphragm 530, and the first and second terminal of one or more of terminals 515. The top plate 510 and the switch plate 540 may connect together capturing the diaphragm 530 and the contact 520. The top surface 1200 of the switch plate 540 may be mated with the bottom surface 1101 of the top plate 510 and the tabs 1105 of the top plate 510 may be aligned with the tabs 1205 of the switch plate 540. The top plate 510 and the switch plate 540 may be fastened together by one or more fasteners 512 extending through the throughholes 1120, 1207 of the tabs 1105, 1205.

The diaphragm 530 may be able to flex within the interior volume of the switch 230. For example, the diaphragm 530 may be held in place within the upper volume 1240 of the switch plate 540. The top plate 510 and the switch plate 540 may compress the outer flange 1300 of the diaphragm 530. The top surface of the outer flange 1300 may contact the bottom mating surface 1140 of the top plate 510 and the bottom surface 1350 of the diaphragm 530 may contact the inner surface 1202 of the switch plate. The bottom mating surface 1140 and the inner surface 1202 may compress the diaphragm 530 forming a substantially air tight seal around the exterior of the diaphragm 530. The center portion of the diaphragm 530 may be substantially unrestrained. By restraining the exterior of the diaphragm 530 but not the interior of the diaphragm 530, the interior of the diaphragm 530 may be allowed to flex up and down within interior volume of the switch 230 functioning as a diaphragm. As the diaphragm 530 flexes, the top surface 1340 may move toward the top plate 510.

As indicated the contact 520 may also be movable within the interior volume of the switch 230. The contact 520 may be positioned between the diaphragm 530 and the top plate 510. The lower engagement surface 1460 may contact the tops of one or more of the supports 1216. The diaphragm 530 may receive the contact 520 into the inner volume 1360 to rest upon the supports 1320. As the diaphragm 530 flexes, the contact 520 thereon moves toward the top plate 510.

The terminals 515 may be inserted through the through holes 1160 extending through the terminal standoffs 1102 on the top plate 510. In this configuration, the upper engagement surface 1400 of the contact 520 may be positioned opposite the terminals 515 such that the upper engagement surface 1400 is positioned proximal to the terminals 515. In a first position, the contact 520 is not in contact with the terminals 515 resulting in a normally open circuit. In a second, actuated position, the contact 520 is in contact with both of the terminals 515 to form a closed circuit. In one example, the contact 520 may be moveably positioned by the diaphragm 530 to connect with and disconnect from the terminals 515.

The lower wall 1220 of the switch plate 540 defining the lower volume 1230 may receive one or more seals 542. The seals 542 may seal against the fluid conduit 110. The chamfer 1270 may be configured to guide the seals 542 and/or the fluid conduit 110 into the lower volume 1230. The lower wall 1220, the seals 542, and the outside wall of the actuator fluid conduit 110 may be in a substantially air tight contact with one another. The fluid conduit 110 connects the actuator 240 to the switch 230. The actuator 240 and the switch 230 are in fluid communication with one another by a fluid (e.g., air, water, oil) contained within the fluid conduit 110.

In exemplary embodiments, the various parts as discussed herein may be manufactured from any known or developed material or by any known or developed process. For example, machining, molding, extruding, b 3-D printing, etc. Various materials may be particularly useful to the manufacture of certain parts. For example, the bellows 560 and the diaphragm 530 may be configured to deform, flex, or stretch. For example, the bellows 560 and the diaphragm 530 may be manufactured from rubber, plastic, silicone, or like materials. It may also be understood that these parts may be formed from other materials such as various metals.

In exemplary embodiments, the actuator fluid conduit 110 and the fluid conduit 120 may be configured in a variety of manners. For example, the fluid conduit 120 and the actuator fluid conduit 110 may define a first channel 100 and a second channel 102, respectively. FIGS. 16-20 illustrate a variety of embodiments in which the actuator fluid conduit 110 and the fluid conduit 120 may be configured. As illustrated in FIGS. 16A and 16B, the first channel 100 may be formed by the first tubing 1620 and the second channel 102 may be formed by the second tubing 1610. The first tubing 1620 and the second tubing 1610 may be similar in size (e.g., inside diameter or outside diameter). The first tubing 1620 and the second tubing 1610 may be attached by a rib or web 1630 extending between their relative walls.

As illustrated in FIGS. 17A and 17B, the first channel 100 may be formed by a first tubing 1720 and the second channel 102 may be formed by a second tubing 1710. The first tubing 1720 and the second tubing 1710 may be dissimilar in size. For example, the second tubing 1710 may be smaller in diameter (e.g., inside diameter or outside diameter) than the tubing 1720. In another example, the first tubing 1710 may be larger in diameter (e.g., inside diameter or outside diameter) than the second tubing 1720. The first tubing 1710 and the second tubing 1720 may be attached by a rib or web 1730 extending between their relative walls.

As illustrated in FIGS. 18A and 18B, the first channel 100 may be formed by a first tubing 1820 and the second channel 102 may be formed by a second tubing 1810. The first tubing 1820 may be substantially concentric with the second tubing 1810. The wall of the first tubing 1820 may separate any fluids flowing in the first channel 100 from any fluids flowing in the second channel 102. The wall of the first tubing 1820 and the wall of the second tubing 1810 may be separated by a plurality of ribs 1830. The ribs 1830 may extend radially away from the outer wall of the first tubing 1820 and connect with an inner wall of the second tubing 1810. In this embodiment, the second channel 102 may thus be found as a plurality of channels of arcuate cross section separated by the longitudinal ribs 1830 and surrounding the first tubing 1820.

As illustrated in FIGS. 19A and 19B, the first channel 100 may be formed by a first tubing 1920 and the second channel 102 may be formed by the second tubing 1910. The first tubing 1920 may be substantially concentric with the second tubing 1910. While, the first tubing 1920 may be substantially concentric with the second tubing 1910, there may be no positioning component holding the first and second tubing 1920, 1910 concentrically with respect to each other (such as by rib 1830 in the embodiment of FIGS. 18A and 18B). As such, the first tubing 1920 and the second tubing 1910 may float relative to one another. The wall of the first tubing 1920 may separate any fluids flowing in the first channel 100 from any fluids flowing in the second channel 102.

As illustrated in FIGS. 20A and 20B, the first channel 100 may be formed by a first tubing 2020 and the second channel 102 may be formed by a second tubing 2010. The second tubing 2010 may wrap helically around the first tubing 2020. The first tubing 2020 and the second tubing 2010 may be dissimilar in size. For example, the second tubing 2010 may be smaller in diameter (e.g., inside diameter or outside diameter) than the first tubing 2020. In another example, the second tubing 2010 may be larger in diameter (e.g., inside diameter or outside diameter) than the first tubing 2020.

As illustrated in FIGS. 1-4, the fluid conduit 110 may connect the actuator 240 located inside the handle 130 to the switch 230 located inside the base 140. Referring to FIG. 5, the actuator 240 is configured to receive force from a user. The force then acts on a fluid contained within the actuator 240. The action on the fluid may be communicated to the switch 230. By receiving the fluid communication of the actuator 240, the switch 230 may be configured to, at least temporarily, close a contact. This change in contact state may cause the pump 220 to alter states between start and stop or other functionality.

In exemplary embodiments, referring to FIGS. 1 and 2, the reservoir 150 is configured to store a first fluid (e.g., water) for delivery to the handle 130. When active, the pump 220 draws the first fluid from the reservoir 150 through the fluid conduit 152 to the pump inlet 222. The pump 220 then forces the first fluid through the pump outlet 224 and into the fluid conduit 120 to the handle 130. While the pump continues to operate, the first fluid is continuously directed to the handle 130 and out the tip 134. The base 140 may be configured to contain various components of an oral hygiene system. For example, the base 140 may contain the pump 220, motor 210, the actuator 240, the circuit board 250, the microprocessor 260, the switch 230, and their various connections. The reservoir 150 may be configured to hold water or other fluids. The pump 220 may be driven by the electromagnetic actuator 210.

The electromagnetic actuator 210 may receive a signal through the signal supply wires 280 which may be connected to the circuit board 250. The electromagnetic actuator 210 may be controlled by the circuit board 250 and the microprocessor 260. The circuit board 250 and the microprocessor 260 may receive power through the power supply 160. The circuit board 250 and the microprocessor 260 may receive and/or be in communication with the switch 230 through the signal supply wires 270a/b such that the circuit board 250 and the microprocessor 260 may receive a signal from the switch 230.

In exemplary embodiments, the switch 230 may be a mechanical, normally open contact. The switch 230 may close temporarily when the pressure rises within the switch 230. When the switch 230 contact closes, it may provide a signal to the microprocessor 260 on the circuit board 250. The circuit board 250 may control the power to the electromagnetic actuator 210. The circuit board 250 may toggle the electromagnetic actuator 210 between on and off each time the switch 230 closes (e.g., the operator pushes the button 570 on the actuator 240 to close the contact in the switch 230). In one embodiment, the microprocessor 260 may send a first signal through a first supply wire 270a forming a first connection with the switch 230 via a first terminal 515. In response to a contact closing in the switch 230, the controller may receive that signal back from the switch 230 through a second supply wire 270b forming a second connection with the switch 230 via a second terminal 515. In other embodiments, the switch 230 may be a ground and only a single signal supply wire 270 (which may be in communication with one or more of terminals 515) may be connected between the switch 230 and the circuit board 250. In such an embodiment, when the connection is closed in the switch 230, the circuit board 250 and the microprocessor 260 may recognize the ground and switch motor states. In exemplary embodiments, the circuit board 250 may cause the electromagnetic actuator 240 to switch states (e.g., change from an on to off or from an off to an on state.)

The motor 210 may be configured to drive the pump 220. A first motor states (e.g., the electromagnetic actuator 210 in the “on” state) may cause the pump 220 to send the first fluid from the reservoir 150 to the handle 130. A second motor state (e.g., the electromagnetic actuator 210 in the “off” state) may cause the pump 220 to stop sending the first fluid to the handle 130.

The handle 130 is fluidly connected to the base 140 through both the fluid conduit 120 and the actuator fluid conduit 110. The handle 130 may receive a first fluid from the pump outlet 224 on the pump 220. The handle 130 may dispense the first fluid out of the tip 134. Generally, a user may operate the handle 130 with a single hand. The actuator 240 may be configured to actuate an on/off switch. In particular the actuator 240 may be located on the handle 130 such that it is easily accessible to the hand operating the handle 130. The actuator 240 may be operable to trigger the switch 230. The second fluid may be utilized to place the actuator 240 in fluid communication with the switch 230. For example, the second fluid may be water, air, oil, or any similar fluid capable conveying an input force at the actuator 240 to the switch 230.

In one embodiment, a user may depress the button 570 and the contact surface 940 of the button 570 contacts the bellows 560 and compresses the spring 590. In instances where the user force is sufficient to overcome a biasing force exerted by the spring 590, the button 570 deforms the structure of the bellows 560, thereby decreasing the volume 700 within the bellows 560. The back plate 550 may receive the bellows 560 such that the two components may be configured to contain the second fluid within their interior volume. When an operator presses down the button 570, the bellows 560 is compressed and the second fluid contained within the volume 700 of the button 570 may be forced through the inlet 664 in the back plate 550 into the actuator fluid conduit 110.

The one or more seals 552 may provide an air-tight seal between the actuator fluid conduit 110 and the back plate 550, but other techniques for creating the seal may also be used (e.g., press-fits, adhesives, barbed fittings, etc.). The spring 590 may be positioned within the volume defined by the interior of the back plate 550 and the bellows 560. The collar 580 may be configured to retain the assembly of the back plate 550, the spring 590, the bellows 560, and the button 570. Once the user releases the button 570, the spring 590 exerts a biasing force against the inner surface 722 of the bellows 560 returning the bellows 560 its original uncompressed state. As the bellows 560 expands due to the spring force, the volume 700 of the bellows 560 may return to its original size. Typically, the spring 590 may be supple enough to be depressed by the hand operating the handle 130. However, the spring 590 may strong enough to return to its extended state and return the bellows 560 to its original volume after being depressed. As the bellows 560 returns to its original volume, the second fluid is drawn back into the interior volume 700 of the bellows 560 and the back plate 550 and the pressure within the actuator system 240 is reduced. While the spring 590 is illustrated as a coil spring, the spring 590 may be any material or component configured to be compressible and then return to its original shape.

The switch 230 may receive the second fluid forced out of the actuator 240. The switch plate 540 may be connected with a fluid tight connection to the actuator fluid conduit 110 with one or more seals 542. The diaphragm 530 may be operable to change size, shape, volume, or the like due to the force applied by the second fluid. As indicated above, the diaphragm 530 may be restrained on at least a portion of its outer periphery. For example, the diaphragm 530 may be constrained by one or more of the switch plate 540 and the top plate 510. This constraint on the outer periphery may be a fluid tight seal configured to keep the second fluid from escaping the edges of the diaphragm 530 and instead deforming the center of the diaphragm 530. The lower portion of the diaphragm 530 may form a volume with the inner surface 1202 of the switch plate 540. The second fluid may enter this volume under pressure caused by the hand operating the handle 130 forcing the fluid out of the actuator 240. This fluid force at the switch 230 causes the diaphragm 530 to flex. The diaphragm 530 may be configured to release a small amount of the second fluid through he one or more weep holes 1332. Similarly the second fluid may be drawn back into the system through the one or more weep holes 1332. The one or more weep holes 1332 may be particularly beneficial when used with compressible gasses such as air. The one or more weep holes 1332 may allow the switch 230 to work regardless of the ambient barometric pressure. If external pressures change too much, a fluid pressure system may not work because there may not be enough air pressure in the bellows 560 to deflect the diaphragm 530. With the one or more weep holes 1332 in the diaphragm 530, the pressure within the bellows 560 may be the same as atmospheric pressure allowing for the diaphragm 530 and the bellows 560 to return to their natural, non-compressed shape when the push button is released.

The diaphragm 530 and the contact 520 may be positioned such that movement of the diaphragm 530 also moves the contact 520. The diaphragm 530 and the contact 520 may be configured such that under fluid pressure the diaphragm 530 flexes and causes the contact 520 to contact the terminals 515. Each of the terminals 515 may provide electrical communication from the outside of the switch 230 to the interior of the switch 230 and vice versa. The terminals 515 are configured to contact the contact 520. The contact 520 may be configured to communicate a signal from one of the terminals 515 to the other of the terminals 515. The top plate 510 may be configured to secure the one or more of terminals 515. The top plate 510 may also be configured to restrain the diaphragm 530 with or without the switch plate 540. One or more of the top plate 510, the diaphragm 530, and the switch plate 540 may be configured to direct the contact 520 against the one or more of terminals 515 in response to the diaphragm 530 flexing. One or more fasteners 512 may be configured to fasten the top plate 510 against the switch plate 540 containing the one or more of terminals 515, the contact 520, and the diaphragm 530 within the interior volume formed by the top plate 510 and the switch plate 540.

To minimize damage (cuts, kinks, etc.) and for aesthetic reasons, the actuator fluid conduit 110 may be routed alongside the fluid conduit 120. The fluid conduit 120 may be a typical conduit used in countertop oral irrigators configured to transport water from the pump 220 to the handle 130. However In exemplary embodiments, the fluid conduit 110 may be merged with the pump 220 into a dual-lumen tube. The actuator fluid conduit 110 may also be a separate tube, which is spiral-wrapped around the fluid conduit 120. The actuator fluid conduit 110 may also be attached to the fluid conduit 120 by a feature such as a connecting rib. However, regardless of the configuration, the actuator fluid conduit 110 and the fluid conduit 120 may be configured to maintain fluid communication between the base 140 and the handle 130. The fluid communication may be accomplished using a first fluid and a second fluid. The first and second fluid may be the same. The first and second fluid may be the different. The first and second fluid may both be a non-compressible fluid like water. The first fluid may be non-compressible like water while the second fluid is a compressible fluid like air.

In exemplary embodiments, as illustrated in FIG. 21, a method for activating and deactivating an oral hygiene pump may include changing the activation state of motor utilizing a button on an oral irrigator handle. A signal (e.g., a start/stop signal) may be transmitted from a processor on a circuit board (referred to in FIG. 21 as a controller) to a switch through a first terminal. (Step 2100) A button on the handle of an oral irrigator may be depressed. Depressing the button may increase a fluid pressure within the oral irrigator handle. This fluid pressure may be communicated to the switch. (Step 2120) In response, the fluid pressure may close a contact in the switch. The closed contact may connect the first terminal with a second terminal. Closing the contact in the switch may communicate the signal (e.g., start/stop signal) through the second terminal back to the processor and circuit board (i.e., the controller). (Step 2130) Receiving the signal may cause the processor and circuit board to start or stop the motor. Stopping the motor may stop the pump causing the handle to stop receiving water. Starting the motor may start the pump causing the handle to receive water. (Step 2140)

As can be understood from the preceding discussion, the oral irrigator allows a user to activate or deactivate the discharge pressure of the fluid stream emanating from the oral irrigator handle without reaching for the base. Thus, the oral irrigator can be activated or deactivated with a single hand on the oral irrigator handle.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. It should be noted that delivery sheath and delivery catheter may be used interchangeably for purposes of this description. The exemplary drawings are for purposes of illustration only and the dimensions, positions, order and relative sizes reflected in the drawings attached hereto may vary.

While it is appreciated that the discussion herein has been directed and described with reference to various embodiments, it will be understood that changes may be made in the form and detail of the technology without departing from the spirit and scope of the discussion herein. For example, in various embodiments, instead of locating the switch 230 in the base 140, the switch 230 may be located in the handle 130 and utilized to detect a rise in fluid pressure, which happens when a bellows is compressed in the handle 130. In various embodiments, the switch 230 may not appear in the system. Alternatively, an electric connection can also be made where a push button in the handle provides an (electric) signal. The connection may run through between the handle 130 and the base 140 (e.g., along the fluid conduit 120) to the microprocessor 260 inside the base 140. In various embodiments, a wireless connection can also be made where a push button in the handle transmits a wireless signal to a wireless receiver inside the handle 130 similarly triggering the motor to start or stop. It will thus be appreciated that those having skill in the art will be able to devise numerous systems, arrangements and methods which, although not explicitly shown or described herein, embody the principles of the disclosure and are thus within the spirit and scope of the disclosure herein. From the above description and drawings, it will be understood by those of ordinary skill in the art that the particular embodiments shown and described are for purposes of illustration only, and references to details of particular embodiments are not intended to limit the scope of the disclosure herein, as defined by the appended claims.

We claim:

1. An oral irrigator comprising
a reservoir;
a handle;
a tip connected to the handle and in fluid communication with the reservoir;
a base unit including an operating assembly, the operating assembly configured to selectively provide a first fluid from the reservoir to the tip; and
a fluid pressure trigger connected to the handle and including a second fluid, wherein based on a pressure of the second fluid the fluid pressure trigger closes an electrical contact to the operating assembly causing the operating assembly to selectively vary at least one characteristic of the first fluid flow from the reservoir to the tip.

2. The oral irrigator of claim 1, wherein the operating assembly comprises
a motor; and
a pump connected to the motor; wherein
the motor selectively drives the pump; and
the pump provides the first fluid from the reservoir to the tip.

3. The oral irrigator of claim 1, wherein when the electrical contact is closed the fluid pressure trigger is in electrical communication with the motor and actuation of the fluid pressure trigger varies a state of the motor.

4. The oral irrigator of claim 3, wherein in a first state the motor drives the pump to provide the first fluid to the tip and in a second state the motor does not drive the pump.

5. The oral irrigator of claim 1, wherein the fluid pressure trigger comprises
a fluid conduit storing the second fluid;
a switch connected to the fluid conduit; and
an actuator in fluid communication with the fluid conduit; wherein
movement of the actuator causes the second fluid to activate the switch.

6. The oral irrigator of claim 5, wherein the actuator comprises a collapsible bellows connected to the fluid conduit and in fluid communication therewith, wherein the bellows compresses the second fluid as it transitions from a first configuration to a second configuration.

7. The oral irrigator of claim 6, wherein the actuator further comprises
a button connected to the bellows and configured to selectively compress the bellows from the first configuration to the second configuration in response to a user input; and
a spring connected to the bellows, wherein the spring returns the bellows to the first configuration from the second configuration.

8. The oral irrigator of claim 5, wherein the switch comprises
a diaphragm, wherein the diaphragm moves in response to changes in pressure exerted by the second fluid; and
the electric contact of the fluid pressure trigger is formed with or connected to the diaphragm so as to move correspondingly with the diaphragm.

9. The oral irrigator of claim 8 further comprising a processing element in communication with the switch and the motor and when the diaphragm is in a first position the electrical contact completes a circuit to the processing element to activate the switch and when the diaphragm is in a second position the electrical contact opens the circuit to the processing element to deactivate the switch.

10. The oral irrigator of claim 1, wherein the one or more characteristics include at least one of a fluid pressure, a fluid pulse rate, or a fluid flow rate.

11. A countertop water flossing device comprising
a base unit;
a reservoir connected to the base unit;
a pump provided in the base unit and in fluid communication with the reservoir;
an electric switch provided in the base unit and in electrical communication with the pump;
a handle in fluid communication with the pump and removable from the base unit; and
an actuator including an actuator fluid provided on the handle, wherein
the actuator changes a fluid pressure of the actuator fluid to close or open the switch and selectively start or stop the pump.

12. The countertop oral irrigator of claim 11, wherein the switch further comprises
a diaphragm;
an electrical contact connected to or formed with the diaphragm;
an actuator fluid conduit connected to the diaphragm and containing the actuator fluid; and
a bellows connected to the actuator fluid conduit; wherein
movement of the bellows compresses the actuator fluid within the actuator fluid conduit to move the diaphragm; and
movement of the diaphragm causes the electrical contact to selectively activate or deactivate the pump.

13. The counter top oral irrigator of claim 12, further comprising a water conduit connected to the pump and the handle, wherein water from the pump travels through the water conduit to the handle.

14. The countertop oral irrigator of claim 13, wherein one of the actuator fluid conduit or the water conduit is received within the other of the actuator fluid conduit or the water conduit.

15. The countertop oral irrigator of claim 13, wherein actuator fluid conduit is connected to the water conduit and is wrapped around an outer surface of the water conduit.

16. The countertop oral irrigator of claim 13, further comprising a tube defining the actuator fluid conduit and the water conduit.

17. The countertop oral irrigator of claim 12, further comprising
a processing element in selective communication with the electrical contact; and
a motor connected the pump and in electrical communication with the processing element; wherein
the processing element controls a voltage provided to the motor to selectively activate or deactivate the pump, the voltage depending on whether the electrical contact is in electrical communication with the processing element.

18. The countertop oral irrigator of claim 17, wherein
when the electrical contact is in electrical communication with the processing element, the processing element provides an off voltage to the motor; and
when the electrical contact is not in electrical communication with the processing element, the processing element provides an on voltage to the motor.

19. A method of controlling a pump in a base of an oral irrigator from a tethered handle of the oral irrigator comprising
transmitting a signal for a controller of the countertop pump to a switch through a first terminal;
pressing a button located on the handle;
increasing a fluid pressure within handle;
communicating the increased fluid pressure to a switch located in the oral irrigator base;
closing a contact in the switch by inflating a diaphragm within the switch with the fluid pressure;
transmitting the signal from the first terminal to a second terminal through the closed contact;
receiving the signal at the controller; and
altering the state of a motor in response to receiving the signal at the controller.
